(19) United States
(12) Patent Application Publication
(10) Pub. No.: US 2024/0154833 A1
(43) Pub. Date: May 9, 2024

(54) MEETING INPUTS

(71) Applicant: Hewlett-Packard Development Company, L.P., Spring, TX (US)

(72) Inventors: Rafael Zotto, Porto Alegre (BR); Manuela Ferreira De Oliverira, Partenon Porto Alegre/ RS (BR); Fernanda Fonseca Serrate, Partenon Porto Alegre/ RS (BR); Andrea Capra Galina, Partenon Porto Alegre/ RS (BR)

(21) Appl. No.: 17/769,309

(22) PCT Filed: Oct. 17, 2019
(86) PCT No.: PCT/US2019/056695

§ 371 Date: Apr. 14, 2022

(51) Int. Cl. H04L 12/18; G10L 13/02; G10L 15/26

(52) U.S. Cl. CPC H04L 12/1831; G10L 13/02; G10L 15/26

(57) ABSTRACT

An example system may include a processor and a non-transitory machine-readable storage medium storing instructions executable by the processor to generate synthesized speech from a non-speech input of a first attendee to a device logged into a meeting through a conferencing platform at the device; and deliver the synthesized speech to a second attendee to the meeting as audio input into the conferencing platform.

### BACKGROUND

Devices and device users are connected via data and telecommunication networks. Geographically dispersed users can meet virtually and exchange ideas utilizing these connections. For example, conferencing platforms may be utilized to organize and/or host a meeting among distributed attendees. Rather than having to attend meetings in person, conferencing platforms may allow meeting attendees to attend a meeting virtually from remote locations. An attendee's ability to communicate may influence their ability to utilize conferencing platforms.

### BRIEF DESCRIPTION OF THE DRAWINGS

FIG. 1 illustrates an example of a system for generating meeting inputs consistent with the present disclosure.

FIG. illustrates another example of a system for generating meeting inputs consistent with the present disclosure.

FIG. 3 illustrates an example of a non-transitory machine-readable memory and processor for generating meeting inputs consistent with the present disclosure.

FIG. 4 illustrates an example of a method for generating meeting inputs consistent with the present disclosure.

### DETAILED DESCRIPTION

Conferencing platforms may include platforms for organizing and hosting a virtual meeting. Conferencing platforms may include applications utilizable via a computing device to organize and host a virtual meeting as a service to a user. The applications may be web-based. The conferencing platform and/or the underlying conferencing service may be provided by a conferencing platform provider. The conferencing platform provider may include an entity that develops, provides, and/or maintains conferencing platforms and/or back end infrastructure such as servers that are utilized to provide the conferencing service. The applications may operate via a connection to a conferencing platform provider's server. The applications may include a component that is installed at and/or is operated via a user's computing device.

A conferencing platform may include instructions executable by a processor to organize and/or host a meeting that attendees may remotely join and/or participate in. Examples of conferencing platforms may include Skype, Zoom, Teams, etc. The conferencing platform may host audio and/or video sharing among the meeting attendees in order to facilitate discussion and/or the sharing of ideas.

Each of the attendees may utilize the conferencing platform to join and/or participate in the meeting. For example, each of the participants may execute the conferencing platform application on their local device and/or through a browser executing at their local device to join and/or participate in the meeting. The conferencing platform may provide access to the meeting to each of the attendees when executing on their device. In some examples, the conferencing platform may provide a unique identifier, token, login information, an active link, and/or other security mechanism to be utilized to identify and allow the attendee to participate in the particular meeting hosted by the conferencing platform.

During the meetings attendees may interact with one another utilizing auditory communication. For example, an attendee may speak into a microphone (e.g., in a telephone, in a headset, integrated into a computing device, a stand-alone microphone, integrated into a conference phone, etc.) to communicate their ideas. The audio of the attendee that is speaking may be broadcast to the other attendees. The other attendees of the meeting may listen to the audio of the attendee that is speaking. When the other attendees wish to contribute to the meeting they may speak into their microphone.

A person may wish to participate in a meeting that is hosted by the conferencing platform. However, a person may have impairments that interfere with their ability to utilize the conferencing platform to participate in the meeting. For example, a person may have a physical and/or mental impairment such as a disability. For example, a person may be hard of hearing, deaf, or have some other mental or physical disability that prevent the person from being able to receive and/or comprehend audio from the conferencing platform. A person may also have a disability that impairs their ability to speak and/or otherwise communicate through audible means that may be broadcasted by the conferencing platform and/or comprehended by other attendees utilizing the conferencing platform.

Additionally, a person that wishes to participate in the meeting hosted by the conferencing platform may face situational impairments to their participation. For example, the person may be in a location where they are not able to hear the audio broadcasted by the conferencing platform due to background noise and/or privacy concerns. For example, the person may be in a noisy location where the audio from the conferencing platform may not be clearly audible over the background noise. Or the person may be in a non-private location where the audio broadcasted by the conferencing platform may be overheard by people that the person does not want to be able to listen in. Likewise, the person may be in a noisy location where their voice may not be clearly heard over background noise. Further, the person may be in a non-private location where the words they speak may be overheard by people that the person does not want to be able to listen in.

The inability of an attendee to participate in a meeting may disrupt and/or impair the exchange of information that can occur during the meeting by impairing the participation of attendees. Additionally, it may be frustrating for the attendee whose participation is impaired. The impaired participant may have feelings of loneliness, isolation, and frustration due to their inability to participate. They may feel professionally and/or socially stunted and uncomfortable.

In some examples, an impaired participant may rely on an interpreter in the room with them to translate (e.g., translate to sign language, translate by lip reading, translate by speaking directly to the impaired participant at an elevated volume, etc.) the audio for the impaired participant. However, such an arrangement may cause the impaired participant to rely on an intermediate person which may further alienate the impaired participant and make them feel uncomfortable and burdensome to the meeting group. The presence and actions of the interpreter may interfere with the flow of the meeting and pose a distraction to other attendees.

In contrast, examples consistent with the present disclosure may provide an attendee with the ability to autonomously participate in a meeting hosted by a conferencing platform without the involvement of an interpreter and without the modification to and/or reliance upon native features of the conferencing platform. That is, examples consistent with the present disclosure may include a system that seamlessly integrates with existing conferencing platforms to provide an attendee with the tools to overcome their impairments and participate in the meeting without involving modification to the conferencing platform application.

For example, examples consistent with the present disclosure may include a system including a processer and a non-transitory machine-readable storage medium to store instructions executable by the processor to: generate synthesized speech from a non-speech input of a first attendee to a device logged into a meeting through a conferencing platform at the device, and deliver the synthesized speech to a second attendee to the meeting as audio input into the conferencing platform.

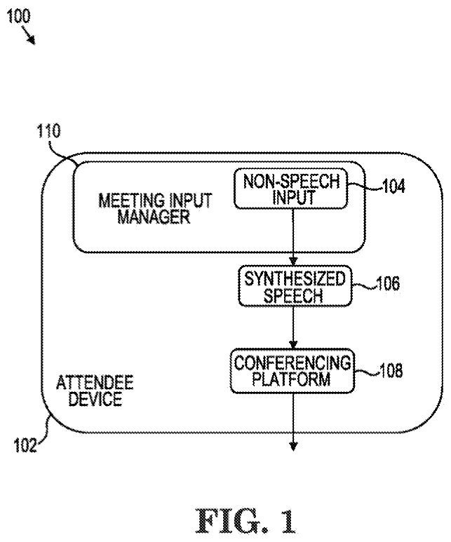

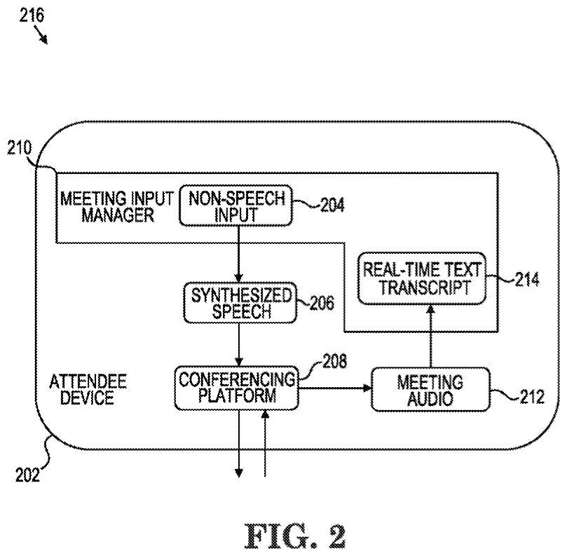

FIG. 1 illustrates an example of a system 100 for generating meeting inputs consistent with the present disclosure. The described components and/or operations of the system 100 may include and/or be interchanged with the described components and/or operations described in relation to FIG. 2-FIG. 4

The system 100 may include and/or be executed utilizing an attendee device 102. The attendee device 102 may include a computing device. The attendee device 102 may include a computing device that belongs to and/or is in the possession of an attendee of a meeting. The attendee device 102 may include a desktop computer, a notebook computer, a tablet computer, a smartphone, a smart device, a wearable computing device, a smart consumer electronic device, conferencing equipment, etc.

The attendee device 102 may include a conferencing platform 108. For example, a conferencing platform 108 may include instructions executable by a processor of the attendee device 102 to give the attendee access to a meeting. The meeting may include a virtual meeting hosted by a conference provider associated with and/or providing the conferencing platform 108.

The conferencing platform 108 may be a conferencing platform available to and/or utilized by each of a plurality of attendees to the meeting. For example, each of a plurality of attendees may utilize instances of the conferencing platform 108 to connect to the meeting hosted by a conference provider associated with and/or providing the conferencing platform 108. Instances of the conferencing platform 108 may execute on the device of each of the plurality of attendees, on servers communicably coupled to the device of each of the plurality of attendees, on conferencing equipment utilized for the meeting, etc. to connect to the meeting hosted by the conference provider. For example, an instance of the conferencing platform 108 executing at the attendee device 102 may be utilized by an attendee to connect, through the conference provider, to other attendees executing instances of the same conferencing platform on their respective devices. The functionality of the conferencing platform 108 and/or its ability to facilitate a meeting may be distributed among a plurality of attendees and/or backend computing devices.

The attendee device 102 may include a meeting input manager 110. A meeting input manager 110 may include instructions executable by a processor of the attendee device 102. The meeting input manager 110 may exist and/or operate separate from the conferencing platform 108. Unlike the conferencing platform 108, the meeting input manager 110 may not utilize and/or rely on communication with other instances of a meeting input manager executing at the devices of other attendees and/or may not utilize and/or rely on communication with other instances of the meeting input manager executing at a server where the conferencing provider is hosting the instructions to connect the attendees. The meeting input manager 110 may not modify the conferencing platform 108 on the attendee device 102, may not modify instances of the conferencing platform on other attendees' devices, and/or may not modify conference provider instructions executing on a server separate from the attendee device 102 to host the meeting. That is, the meeting input manager 110 may be a set of instructions executing natively on the attendee device 102 independently from the conferencing platform 108 and/or its associated conferencing provider.

The meeting input manager 110 may be in communication with and/or interact with the conferencing platform 108 at the attendee device 102. For example, when a conferencing platform 108 launches on the attendee device 102 (e.g., when the meeting begins) the meeting input manager 110 may also be launched. The meeting input manager 110 may determine the conferencing platform type. For example, the meeting input manager 110 may identify the conferencing platform 108 that is executing at the attendee device 102 and/or the conferencing provider that is hosting the meeting.

The meeting input manager 110 may identify a plugin capable of binding to the conferencing platform 108 of the determined type, allow for the delivery of audio into an audio channel utilized by the conferencing platform 108, and/or allow for the capture of meeting audio from the conferencing platform 108. A plugin may include instructions executable to add a specific feature or functionality, such as those described above, to an existing application, such as the conferencing platform 108. The plugin may be one of a plurality of plugins available to the meeting input manager 110. Each plugin may be specific to a corresponding conferencing platform 108 type.

Each plugin may connect directly or indirectly with the conferencing platform 108. For example, the plugin may utilize an existing software development kit (SDK) or application programming interface (API) that may fetch information from and/or deliver information to the conferencing platform 108 at the attendee device 102.

In other examples, the conferencing platform 108 may not offer SDKs or APIs. In such examples, the meeting input manager 110 may communicate with the conferencing platform 108 by performing visual analysis, audio analysis, data processing, pattern recognition, machine learning analysis, etc. of the data generated by and/or received by the conferencing platform 108 at the attendee device 102. For example, the meeting input manager 110 may perform an analysis of audio output by the conferencing platform 108 at the attended device 102 and/or may perform visual analysis of a user interface of the conferencing platform 108 generated at the attendee device 102 in order to capture data utilizable in the functionalities described below. That is, data communication and/or processing at conference provider server and/or instances of the conferencing platform on devices other than attendee device 102 may not matter and/or be considered by the meeting input manager 110. Instead, the meeting input manager 110 may limit its analysis to data at the attendee device 102.

Therefore, the focus on processing data at the attendee device 102 may result in the meeting input manager 110 being a data-at-the-attendee-device-centered utility that may operate in a particular conferencing platform agnostic manner. That is, the meeting input manager 110 may be able to communicate with and/or dynamically adapt communication to a plurality of distinct conferencing platforms 108 and/or conferencing providers in order to capture and/or process the data it utilizes as inputs across a variety of conferencing platform types.

The meeting input manager 110 may accomplish this without altering the instructions themselves and/or the execution of the instructions of the conferencing platform 108 at the attendee device 102. That is, the meeting input manager 110 may provide the various functionalities described herein by communicating with the conferencing platform 108, but without relying on the conferencing platform 108 to provide the functionalities and the data transformations associated therewith.

The attendee device 102 may include a display. The display may be utilized to generate visual representations of a user interface. For example, the display may generate an image of a user interface of the conferencing platform 108. The user interface of the conferencing platform 108 may display information regarding the joining the meeting, participating in the meeting, details of the meeting (e.g., who is speaking, images being shared in the meeting, etc.), details of the meeting participants, etc.

The display of the attendee device 102 may also be utilized to generate an image of a user interface of the meeting input manager 110. The user interface of the meeting input manager 110 may display information taken from the conferencing platform, fields to accept user input, display data generated from data from the conferencing platform 108, and/or graphical components the various functionalities described herein.

As described above, the meeting input manager 110 and the conferencing platform 108 may be launched and/or execute simultaneously at the attendee device 102. The display of the attendee device 102 may simultaneously display both the user interface for the conferencing platform 108 and the user interface of the meeting input manager 110.

For example, the user interface for the conferencing platform 108 and the user interface of the meeting input manager 110 may be simultaneously displayed on the display of the attendee device 102 in a split-screen arrangement. The simultaneous display of the user interface for the conferencing platform 108 and the user interface of the meeting input manager 110 may allow for the meeting input manager 110 to provide the various functionalities described herein simultaneous with and/or in real-time with the attendee's participation in the meeting.

As described above, the attendee may have physical, mental, situational impairments that may interfere with the attendee's ability and/or willingness to speak during the meeting. The impaired attendee may be utilizing the conferencing platform 108 executing at the attendee device 102 to participate in a meeting hosted by the conferencing provider. The attendee device 102 may include a computing device that the impaired attendee may utilize while he/she is participating in the meeting.

The impaired attendee may want to participate in the meeting via the conferencing platform 108. For example, the impaired attendee may wish to pose a question and/or make a comment to the other participants in the meeting. The conferencing platform 108 may operate by and/or through the collection and/or distribution of speech input received at the attended device 102. As such, the impaired attendee's participation may be impaired and/or prevented by the attendee's inability and/or unwillingness to provide speech input to the conferencing platform 108.

However, the impaired attendee may participate by providing a non-speech input 104 to the meeting input manager 110. For example, an attendee may submit a question, comment, etc. to the meeting input manager 110 as a text input, a gesture input, a sign-language input, a graphical input, image input, a symbol input, etc. For example, the impaired attendee may type their non-speech input 104 on a keyboard (e.g., physical, virtual, etc.) of the attendee device 102. The text may be typed into a text accepting field of the user interface of the meeting input manager 110. In other examples, the impaired attendee may enter their non-speech input 104 via a camera and/or other image input accepting component communicably coupled to the attendee device 102.

The non-speech input 104 provided to the meeting input manager 110 may not be visible to the other attendees of the meeting, to the conferencing platform 108, and/or to the conferencing provider hosting the meeting. That is, the non-speech input 104 may be isolated to the attendee device 102, the meeting input manager 110, and/or a server associated with processing inputs on behalf of the meeting input manager 110, but may be segregated from instances of the conferencing platform 108 and/or the conferencing provider hosting the meeting. As such, the non-speech input 104 may not be able to be communicated by and/or accessible to the conferencing platform 108. Regardless of the type of conferencing platform 108 facilitating the impaired attendee's connection to the meeting, the conferencing platform 108 may not have access to the non-speech input 104 and/or other inputs to meeting input manager 110. Likewise, the conferencing platform 108 may not have access to and/or visibility of the portions of the meeting input manager 110 displayed at the attendee device 102.

The meeting input manager 110 may generate synthesized speech 106 from the non-speech input 104. Generating synthesized speech 106 may include transforming the non-speech input 104 into an audible artificial approximation of human speech (e.g., natural-sounding-audio) that may be generated in a variety of languages and/or voices. That is, the non-speech input 104 may be transformed from its original non-speech format to synthesized speech 106 that would be audible to and/or understandable as speech by someone hearing the synthesized speech 106. For example, generating synthesized speech may include a text-to-speech conversion. Generating synthesized speech 106 may, in some examples, include translating the non-speech input 104 from a first human language that it was input as to a second human language that it will be output as. As such, the meeting input manager 110 and/or a synthesized speech 106 generating service may support multiple languages for text-to-synthesized speech translation.

Generating the synthesized speech 106 from the non-speech input 104 may be performed by the meeting input manager 110. That is, the meeting input manager 110 may include instructions executable to synthesize the synthesized speech 106 from the non-speech input 104. The non-speech input 104 may be synthesized into synthesized speech 106 in real-time to its input. In some examples, synthesizing the synthesized speech 106 from the non-speech input 104 may be accomplished by other applications native to the attendee device 102.

In other examples, synthesizing the synthesized speech 106 from the non-speech input 104 may be accomplished by sending the non-speech input 104 to another device (e.g., a remote device hosting a text synthesizing service, etc.) communicably coupled to the attendee device 102, for example, over a communications network. For example, the meeting input manager 110 may stream the non-speech input 104 to a remote device hosting a text synthesizing service for processing in real-time to its input. Streaming may include sending the non-speech input 104 as a sequence of digitally encoded coherent signals, such as data packets, to the remote device at the time it is generated. In examples where the non-speech input 104 is sent to another device to be synthesized into synthesized speech 104, the meeting input manager 110 may receive the synthesized speech 106 back from the device whence it was synthesized.

As described above, the processing of non-speech input 104 and/or its transformation to synthesized speech 106 may occur at the edge (e.g., the attendee device 102, etc.) and/or in a cloud. Regardless of which approach is utilized to create the synthesized speech 106, the meeting input manager 110 may cause the synthesized speech 106 to be input into the conferencing platform 108 to be delivered to the other attendees of the meeting through the conferencing provider. For example, the meeting input manager 110 may play the synthesized speech into an audio channel of the attendee device 102 that is utilized by the conferencing platform 108 to collect audio to be broadcasted to the other attendees of the meeting. For example, the meeting input manager 110 may stream the synthesized speech 106 to the conferencing platform 108 as if it were input to a microphone at the attendee device 102 utilized to capture audio to be broadcast to other meeting attendees.

The conferencing platform 108 may not be aware that the synthesized speech 106 is synthetic audio that is machine-generated from a non-speech input 104. Rather, the conferencing platform and/or the conferencing provider hosting the meeting may treat the synthesized speech 106 as though it was spoken by the impaired attendee. The conferencing platform 108 may deliver the synthesized speech 106 to the other meeting attendees as though it were natural speech from the impaired attendee that was captured at the attendee device 102. For example, the conferencing platform 108 may cause the synthesized speech 106 to be broadcast to the other attendees of the meeting without any additional processing or conversion over what would be applied to natural speech captured at the attendee device 102.

As described above, the meeting input manager 110 may capture non-speech input 104 in real-time and/or simultaneous with its input. The meeting input manager 110 may cause the non-speech input 104 to be processed and/or synthesized into synthesized speech 106 in real-time and/or simultaneous with its input. The meeting manager 110 may also deliver the synthesized speech 106 to the conferencing platform 108 in real-time and/or simultaneous with its input and/or the generation of the synthesized speech 106.

In order to seamlessly integrate the synthesized speech 106 into the meeting, the meeting input manager 110 may coordinate the delivery of the synthesized speech 106 to and/or through the conferencing platform 108 in a manner that adheres to conversational norms. Conversational norms may include the pacing, etiquette, turn taking, interruption avoidance, deference, etc. that are common to polite conversation. Conversational norms may vary across languages, cultures, etc. As such, the meeting input manager 110 may coordinate the delivery of the synthesized speech 106 to and/or through the conferencing platform 108 in a manner that adheres to the conversational norms of the language, culture, etc. native to the conference.

In some examples, the meeting input manager 110 may coordinate the delivery of the synthesized speech 106 to and/or through the conferencing platform 108 in a manner that avoids conversational overlap and/or other interruptions in communication. For example, in order to avoid conversational overlaps and/or other interruptions caused by broadcasting the synthesized speech 106 via the conferencing platform 108 while other meeting attendees are also speaking, the meeting input manager 108 may monitor meeting audio to identify communication gaps.

For example, the meeting input manager 110 may monitor the meeting audio received at the attendee device 102 via the conferencing platform 108. The meeting input manager 110 may analyze the meeting audio of other meeting attendees delivered to the attendee device 102 via the conferencing platform 108 to identify communication gaps. In some examples, in order to identify communication gaps the meeting input manager 110 may monitor data at the conferencing platform 108 that indicates whether an attendee is speaking. For example, the meeting input manager 110 may monitor a status indicator visible on the user interface of the conferencing platform 108 that indicates if/when an attendee is speaking and/or which attendee is speaking.

Identifying communication gaps may include identifying pauses and/or gaps in the meeting audio. For example, the meeting input manager 110 may identify when no other attendee of the meeting is speaking based on the identified pauses or gaps in the audio of the meeting attendees. Communication gaps may vary from speaker to speaker. For example, some people may speak with a relatively fast pace or cadence with relatively few and/or abbreviated pauses between words and/or sentences. Other people may speak with a relatively slow pace or cadence that results in relatively more and longer pauses between words and sentences. As such, identifying communication gaps may include identifying, on a speaker-by-speaker basis a natural pace or cadence of speech utilized by the speaker. As such, a communication gap that is conversationally appropriate (e.g., the conclusion of a thought or statement) to accommodate an interjection may be identified as opposed to a gap between words and/or sentences due to cadence rather than the conclusion of a thought or statement.

The meeting audio may be delivered to the attendee device 102 via the conferencing platform 108 in real-time and/or simultaneous with the other attendees speaking. The meeting audio may be analyzed in real-time and/or simultaneous with being received by the attendee device 102 via the conferencing platform 108. As such, the meeting input manager 110 may identify, in real-time and/or simultaneous with receiving the audio, the communication gaps that occur during the meeting.

In natural conversation, conversation participants may wait for a communication gap to begin to speak. However, some attendees may have physical, mental, and/or situational impairments that may interfere with their ability to identify the communication gaps in the meeting during which it may be conversationally appropriate to interject their input to the meeting. For example, if an attendee is hard of hearing, then they may not be able to identify when the other attendees are speaking and/or not speaking during the meeting. As such, the attendees with the impairments may not be able to identify a conversationally appropriate time (e.g., during a communication gap) for their synthesized speech 106 to be delivered into an audio channel utilized by the conferencing platform 108.

In some examples, the conferencing platform 108 and/or the operation of devices utilized to access the meeting (e.g., speaker phone, audio processing of attendee devices, smartphones, etc.) may operate in a half-duplex mode. Half-duplex mode may include where one attendee is allowed to transmit audio at a time. For example, a conference phone connecting to the meeting may not have full-duplex functionality and may allow one-way conversation. Full-duplex mode may include where more than one attendee is allowed to transmit audio at a time. As such, if a meeting input manager 110 were to cause the delivery of the synthesized speech 106 into the audio channel utilized by the conferencing platform 108 while another of the meeting attendees was speaking (e.g., while the single communication channel is currently occupied by the another meeting attendees voice), the synthesized speech 106 may not be transmitted to and/or heard by the other attendees to the meeting.

As described above, the meeting input manager 110 may be utilized to identify communication gaps in real time. Additionally, the meeting input manager 110 may be utilized to delay the delivery of the synthesized speech 106 to the conferencing platform 108 for broadcast by the conferencing platform 108 until a real-time communication gap is identified in the meeting audio. For example, the meeting input manager 110 may hold synthesized speech 106 until a real-time communication gap is identified, at which point the meeting input manager 110 may stream the synthesized speech 106 into the conferencing platform 108 for broadcast to the other meeting attendees.

As described above, the user interface of the meeting input manager 110 may include a field for accepting a non-speech input 104. The non-speech input 104 may be processed in real-time to generate synthesized speech 106. The user interface of the meeting input manager 110 may include a plurality of virtual buttons associated with the field for accepting non-speech input 104 that may be utilized to control how and/or when the resulting synthesized speech 106 is delivered to the conferencing platform 108.

For example, the user interface of the meeting input manager 110 may include a first virtual button that, when selected by the impaired attendee providing non-speech input 104 to the attendee device 102, causes the immediate delivery of the synthesized speech 106 generated from the non-speech input 104 to the conferencing platform 108. For example, selection of this first virtual button may cause the audio of the synthesized speech 106 to be streamed into the audio channel utilized for audio inputs into the conferencing platform 108 as soon as it is finished processing and/or without regard to whether another meeting attendee is speaking. This may result in the interruption of another attendee that may be speaking at the time of delivery, the synthesized speech 106 not being heard by other attendees if another attendee is speaking at the time of delivery, and/or the immediate broadcast of the synthesized speech 106 by the conferencing platform 108 at the time of delivery.

The user interface of the meeting input manager 110 may include a second virtual button that, when selected by the impaired attendee providing non-speech input 104 to the attendee device 102, causes the delivery of the synthesized speech 106 generated from the non-speech input 104 to the conferencing platform 108 to be delayed. For example, selection of this second virtual button may cause the streaming of the audio of the synthesized speech 106 to the audio channel utilized for audio inputs into the conferencing platform 108 to be delayed until the meeting input manager 110 has detected a communication gap. The meeting input manager 110 may not interrupt the real-time processing of the non-speech input 104 to generate the synthesized speech 106 in real-time. However, the meeting input manager 110 may wait to deliver that synthesized speech 106 to the conferencing platform 108 until it may be delivered within a communication gap. The synthesized speech 106 may be stored in a buffer. For example, the synthesized speech 106 may be temporarily stored in a memory location awaiting delivery to the conferencing platform 108 until the meeting input manager 110 has identified a communication gap. This may result in the synthesized speech 106 being delivered to the other attendees of the meeting via the conferencing platform 108 at a conversationally appropriate time (e.g., within a communication gap) that does not interrupt, overlap with, and/or become canceled out by the speech of other attendees in the meeting.

However, some meeting attendees may monopolize meeting conversation and/or speak uninterrupted for long periods of time. Further, some meetings may include a plurality of attendees that tend to interrupt each other in a manner that results in few communication gaps or communication gaps that are separated by long periods of time. Under these circumstances, delaying the delivery of the synthesized speech 106 to the conferencing platform 108 until a communication gap is detected may result in a long delay between receiving the non-speech input 104 and broadcasting the synthesized speech 106 into the meeting conversation via the conferencing platform 108. The information that the attendee included in the non-speech input 104 may grow stale as time progresses between communication gaps. For example, if the non-speech input 104 included a question, the question may have already been posed and/or may have already been answered without being posed in the intervening meeting conversation. As such, posing the question again may no longer make sense conversationally. Further, a point raised in the non-speech input 104 may in general lose its saliency as the conversation progresses. For example, a non-speech input 104 such as “what does data point A signify in this figure?” may no longer be salient if the figure being displayed via the conferencing platform 108 has been switched in the intervening moments between communication gaps.

In such examples, the impaired attendee may no longer wish for the non-speech input 104 and/or the synthesized speech 106 resulting therefrom to be delivered to the conferencing platform 108 for delivery to the other attendees. As such, the user interface of the meeting input manager 110 may include a third virtual button (e.g., a button separate from the first and second virtual buttons, another selection of the second virtual button, etc.) that, when selected, cancels the synthesis of the synthesized speech 106 from the non-speech input 104 and/or cancels the delivery of the synthesized speech 106 to the conferencing platform 108 prior to its delivery. This cancelation may correspond to the segment of text that was entered in the text accepting field of the user interface of the meeting input manager 110 when the second virtual button was selected.

Further, the impaired attendee may have initially selected the delivery of the synthesized speech 106 to be delayed. However, the impaired attendee may have changed their mind as the meeting conversation continued without a communication gap. For example, the impaired attendee may wish to have their non-speech input 104 considered before the meeting conversation moves along to a point where it is no longer salient regardless of the presence of a communication gap. In such examples, the user interface of the meeting input manager 110 may include a fourth virtual button (e.g., a button separate from the first and second virtual buttons, another selection of the first virtual button, etc.) that, when selected overrides the previously selected delaying of the delivery of the synthesized speech 106 and triggers the immediate delivery of the synthesized speech 106 to the conferencing platform 108 regardless of whether a communication gap is detected. In other examples, the selection may override the previously selected delaying of the delivery of the synthesized speech 106 and may trigger the immediate delivery of audio of a pre-defined interruption, such as “excuse me, may I ask a quick question,” and then trigger the delivery of the synthesized speech 106 within the next detected communication gap. That is, the meeting input manager 110 may attempt to artificially create a communication gap within which the synthesized speech 106 can be read, by issuing a polite interruption. As such, the meeting input manger 110 may allow the attendee to adhere to conversational norms but also force their way into the meeting conversation when the attendee deems such action appropriate.

Furthermore, in examples where the impaired attendee may have initially selected the delivery of the synthesized speech 106 to be delayed, the impaired attendee may desire to edit a portion of but not entirely replace a non-speech input 104. For example, while waiting for the communication gap to be detected to trigger delivery of the non-speech input 104 to the conferencing platform 108, the impaired attendee may notice a typographical error, a logical error, and/or an unclear point that may be ameliorated by editing the non-speech input 104. In such examples, the attendee may select a fifth virtual button (e.g., a button separate from the first and second virtual buttons, another selection of the first and/or second virtual buttons, etc.) that, when selected reopens the non-speech input 104 for editing and delays the synthesis and/or delivery of the corresponding synthesized speech 106 until the editing is closed regardless of whether a communication gap is detected.

Although some of the above described examples are described in terms of involving the selection of buttons, the examples are not intended to be limited as such. Instead, the delivery, delay, cancellation, editing, etc. of non-speech inputs 104 and/or their resulting synthesized speech 106 may be communicated by a variety of mechanisms other than the selection of a button. That is, examples including the selection of buttons are non-limiting examples describing a manner in which an impaired attendee may communicate their commands to the attendee device 102.

FIG. 2 illustrates an example of a system 216 for generating meeting inputs consistent with the present disclosure. The described components and/or operations of the system 216 may include and/or be interchanged with the described components and/or operations described in relation to FIG. 2-FIG. 4

The system 216 may include and/or operate utilizing the attended device 202 as described above with reference to the similar elements of FIG. 1. The system 216 include the meeting input manager 210 for accepting non-speech input 204 and causing the non-speech input 204 to be synthesized into synthesized speech 206 to be delivered to the conferencing platform 208 as described above with reference to the similar elements of FIG. 1.

As described with reference to FIG. 1, an attendee may have mental, physical, and/or situational impairments that interfere with the attendee's ability to provide speech input to the conferencing platform 208. These same impairments and/or others may interfere with an attendee's ability to hear and/or comprehend the meeting audio 212 delivered to the attendee device 202 via the conferencing platform 208. For example, if an attendee is hard of hearing they may not be able to hear the meeting audio 212 being provided via the conferencing platform 208.

The meeting input manager 210 may cause a real-time text transcript 214 of the meeting audio to be generated and/or displayed in real-time on the display of the attendee device. As described above, the user interface of the meeting input manager 210 and the user interface of the conferencing platform 208 may be simultaneously displayed on respective portions of the display. As such, the attended may view the real-time text transcript 214 of the meeting audio 212 while they simultaneously view the user interface of the conferencing platform 208 which may include images of content being shared during the meeting.

The real-time text transcript 214 may include a text-based representation of audio captured from the attendees of the meeting. For example, the real-time text transcript 214 may include a text read out displaying, in real-time, what a meeting attendee presently speaking is saying. The real-time text transcript 214 may include a transcript of the meeting audio that is generated contemporaneous with the delivery of the audio by the meeting attendees via their respective conferencing platform instances. That is, the real-time text transcript 214 may include a text script of the words spoken by an attendee, where the transcript is produced at the same time as and/or immediately following the attendee speaking the words.

For example, the meeting input manager 210 may capture and/or analyze the meeting audio 212 from the conferencing platform 208. The meeting input manager 210 may capture and/or analyze the meeting audio 212 as it is delivered, via the conferencing platform 208, to the attendee device 202. For example, the meeting input manager 210 may analyze and/or capture the meeting audio 212 from a stream of audio to be fed, from the conferencing platform 208, into an audio output channel at the attendee device 202. The meeting input manager 210 may process the meeting audio itself and/or cause separate applications and/or computing devices to process the meeting audio 212 (e.g., forwarding the meeting audio 212 to a real-time transcribing service, etc.). The meeting audio may be digitally recorded, and the recording may be processed and transcribed into a real-time text transcript 214 of the meeting. Transcribing the voice into a real-time text transcript 214 may, in some examples, include translating the meeting audio 212 to generate a real-time text transcript 214 in a language other than the language that the audio is delivered in. For example, transcribing the voice into a real-time text transcript 214 may include the translation from a first human language it was spoken in to a second human language that it will be transcribed as. As such, the meeting input manager 210 and/or transcription service may support multiple languages for speech-to-text translation.

As such, the meeting input manager 210 may adapt the conferencing platform 208 to the specific impairments of the attendee. The meeting input manager 210 may provide this adaptation without involving modification of the conferencing platform 208 on the attendee's device 202 and/or on other devices. Additionally, the meeting input manager 210 may be utilized as a generic conferencing adapter across a plurality of distinct conferencing platforms and/or conferencing providers. Further, the meeting input manager 210 may provide two-way adaptation for attendees to both receive the meeting contents and audio in an adapted format and to participate in the meeting in an adapted format.

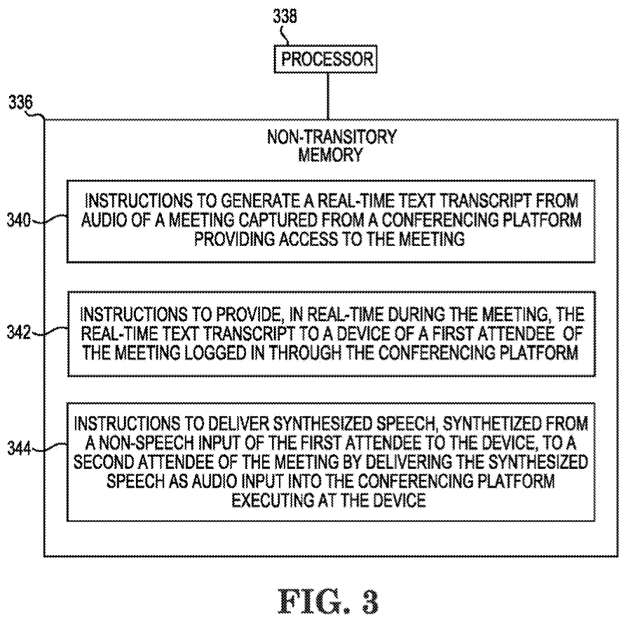

FIG. 3 illustrates an example of a non-transitory machine-readable memory and processor for generating meeting inputs consistent with the present disclosure. A memory resource, such as the non-transitory machine-readable memory 336, may be utilized to store instructions (e.g., 340, 342, 344, etc.). The instructions may be executed by the processor 338 to perform the operations as described herein. The operations are not limited to a particular example described herein and may include and/or be interchanged with the described components and/or operations described in relation to FIG. 1-FIG. 2 and FIG. 4.

The non-transitory memory 336 may store instructions 340 executable by the processor 338 to generate a real-time transcript of a meeting. The real-time transcript may be generated from audio of the meeting. The audio of the meeting may include the audio of attendees speaking during the meeting. In addition, the audio of the meeting may include sounds that are shared during the meeting. For example, the audio may include the audio portion of a video or other presentation aid shared during the meeting.

The attendees may be logged into the meeting, which is hosted by a conferencing provider, via a corresponding conferencing platform executing on their device. In some examples, the attendees may have joined the meeting by calling a telephone number to connect their telephone to the conferencing provider.

The audio from each of the attendees may be collected at the devices that they are utilizing to join and/or participate in the meeting. The conferencing platform executing at each device may be utilized to collect and/or facilitate the delivery of meeting audio at each of the devices.

The real-time text transcript may be generated at an attendee's device. The attendee's device may include a desktop computer, a notebook computer, a tablet computer, a smartphone, a smart device, a wearable computing device, a smart consumer electronic device, conferencing equipment, etc. being utilized to join and/or participate in the meeting.

The audio of the meeting utilized to generate the real-time transcript may be captured from a conferencing platform executing at the attendee's device. The conferencing platform may include an application executing at the attendee's device and/or a web application being executed on behalf of the attendee's device to connect the attendee's device to the meeting. The audio of the meeting may be the audio delivered to the attendee's device to be played for the attendee during the meeting. The audio may be the audio steamed form the conferencing platform into an audio out channel to generate the audio at an audio output device of the attendee's device. In some examples, the audio may be redirected to an audio transcribing service to transcribe the audio into text in real-time and to deliver the transcription to the attendee's device for display in real-time.

The real-time transcript may be supplemented with information that may add context to the transcription of the meeting audio. For example, the real-time transcript may be supplemented with an indicator attributing a portion of the real-time text transcript to an attendee that was identified as having generated the audio. For example, each word, sentence, paragraph, etc. of the real-time transcript may be attributed to an attendee that produced the audio that was transcribed to the word, sentence, paragraph, etc. utilizing indicators (e.g., a name of the attendee, a picture of the attendee, a text color associated with an attendee, an avatar of the attendee, a title of the attendee, contact information of the attendee, etc.) embedded in the real-time text transcript. For example, if Attendee A says, “Good morning, Everyone!”, then the portion of the text transcript reading “Good morning, Everyone!” may appear next to a picture of Attendee A in the text transcript.

To accurately attribute a portion of meeting audio to the attendee that produced it, the attendee generating the audio may be identified by various means. For example, the audio of the meeting captured from the conferencing platform providing access to the meeting may be analyzed to identify a speaking attendee. For example, voice recognition analysis may be performed on the audio of the meeting captured from the conferencing platform. A voice profile identified in the meeting audio may be compared against and matched to a voice profile of a known attendee. When a match is identified, the portion of the real-time text transcript may be attributed to the known attendee and the text may be associated with an indicator of the known attendee's identity. A voice profile for attendees of the meeting may be collected via various mechanisms. For example, a self-registering approach may be utilized where attendees register their voice proactively with a meeting input manager. In another example, a collaborative approach may be utilized where some of the attendees can help identify a voice profile by identifying to the meeting input manager the identify of an attendee that is speaking.

In another example, the attendee generating a portion of the meeting audio may be identified by image processing. For example, a user interface of the conferencing platform displayed on the attendee device may be analyzed in order to extract the identity of the attendee who is generating audio. For example, a user interface of the conferencing platform may include an area where text or some other indicator appears that indicates who is speaking as the meeting audio is delivered. By processing the images of the user interface of the conferencing platform and visually extracting attendee identity information from these areas, an attendee to be associated with portions of meeting audio may be determined. The portion of the real-time text transcript corresponding to this audio may be attributed to the attendee identified by the image processing and the text of the real-time transcript may be associated with an indicator of the known attendee's identity.

In another example, image processing to identify a speaking attendee may include analysis of images of the attendee who is speaking. For example, if the meeting includes a web camera component where video and/or pictures of attendees speaking are broadcasted and/or displayed by the conferencing platform during the meeting. An image processing technique such as facial recognition may be utilized to process the videos and/or the pictures to identify the attendee generating the audio. The portion of the real-time text transcript corresponding to this audio may be attributed to the attendee identified by the image processing and the text of the real-time transcript may be associated with an indicator of the known attendee's identity.

In some examples, a plugin may utilize an existing software development kit (SDK) or application programming interface (API) that may fetch information from and/or deliver information to the conferencing platform at the attendee device. In such examples, the identity of an attendee generating audio may be directly fetched from the conferencing platform. The portion of the real-time text transcript corresponding to this audio may be attributed to the attendee identified by the image processing and the text of the real-time transcript may be associated with an indicator of the known attendee's identity.

The non-transitory memory 336 may store instructions 342 executable by the processor 338 to provide the real-time text transcript of the meeting audio to the attendee's device that is logged into the meeting through the conferencing platform. The real-time text transcript of the meeting audio may be provided to the attendee device in real-time during the meeting.

The real-time text transcript of the meeting audio may be prepared, delivered, and/or displayed at the attendee's device without additional processing of the meeting audio by the conferencing platform. That is, from the conferencing platform's perspective, the meeting audio is delivered exactly as it would be to a device that is not utilizing the real-time text transcript. For example, the real-time text transcript may be prepared, delivered, and/or displayed by an application other than the conferencing platform.

The non-transitory memory 336 may store instructions 344 executable by the processor 338 to synthesize speech from a non-speech input of an attendee. For example, an attendee attending the meeting through the attendee device may enter a non-speech input to the attendee device. In some examples, the attendee may type text at the attendee device that may be utilized as a non-speech input.

In some examples, the attendee may be presented, at the attendee device, with a selectable list of pre-formatted text inputs that may be utilized as the non-speech input. For example, the attendee may be presented with individually selectable suggested text to be submitted as the non-speech input. The attendee may select, at the attendee device, a pre-formatted text input from the list of pre-formatted text inputs that will be utilized to generate synthesized speech.

The selectable list of pre-formatted text inputs may be populated with words or phrases that commonly appear in conversations concerning the topic being discussed in the meeting, in conversations among the group of attendees attending the meeting, and/or in response to the words or phrases making up a most recent portion of the real-time transcript. For example, the selectable list of pre-formatted text inputs may include commonly used phrases such as “Hi! How are you?”, “How much does it cost?”, “Can I ask you something?”, and/or “Thank you for your time, Goodbye!”.

In some examples, the selectable list of pre-formatted text inputs may be customized to a particular attendee. For example, the selectable list of pre-formatted text inputs may be populated from non-speech inputs previously utilized and/or input by the first attendee. For example, analysis may be performed on real-time text transcripts of meeting audio from the meeting the attendee is presently participating in and/or from meetings that the attendee had previously participated on via the presently executing conferencing platform and/or via a different conferencing platform. The analysis may identify non-speech inputs most frequently utilized by the attendee across the analyzed meetings. A portion of the non-speech inputs identified as most frequently used by this analysis may be utilized to populate the selectable list of pre-formatted text inputs. In some examples, the attendee may be allowed to edit and/or manually enter non-speech inputs to be utilized in the selectable list of pre-formatted text inputs.

The non-speech input, manually input and/or selected from a selectable list, may be utilized to generate synthesized speech. The synthesized speech may be delivered to other attendees of the meeting. For example, the synthesized speech may be delivered as an audio input to the conferencing platform executing at the attendee device. The conferencing platform executing at the attendee device may cause the audio input to be broadcast to the other attendees logged into the meeting.

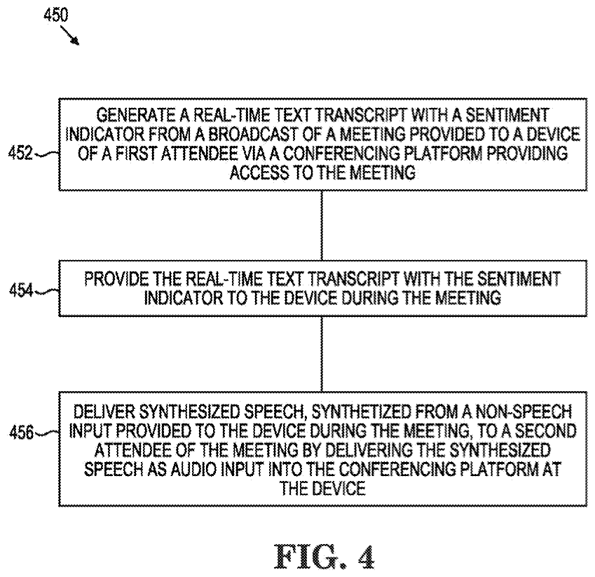

FIG. 4 illustrates an example of a method for generating meeting inputs consistent with the present disclosure. The described components and/or operations of method 450 may include and/or be interchanged with the described components and/or operations described in relation to FIG. 1-FIG. 3.

At 452, the method 450 may include generating a real-time text transcript from a broadcast of a meeting. The broadcast of the meeting may be provided to a device of the attendee via a conferencing platform providing access to the meeting. The real-time text transcript may include a textual representation of the broadcasted audio.

In addition, the real-time transcript may be supplemented with sentiment indicators. The sentiment of a speaker may provide context and be utilized to fully understand and/or interpret the information being communicated by the speaker. As such, including sentiment indicators in the real-time transcript may allow an attendee to understand the sentiment of an attendee as they spoke.

The sentiment of a speaker may include how the speaker was feeling when they spoke or what emotion they intended to communicate when speaking. The sentiment of the speaker may include happy, sad, mad, aggravated, humorous, scared, worried, angry, sarcastic, etc. The sentiment of a speaker may be determined based on analysis of the broadcast audio. For example, the sentiment associated with portions of the broadcast audio may be identified based on the volume, tone, word selection, sentence structure, inflection, etc. of the speech. Additionally, the sentiment of the speaker may be determined based on image analysis. For example, if the meeting includes a web camera component where video and/or pictures of attendees speaking are broadcasted and/or displayed by the conferencing platform during the meeting, a facial expression analysis may be utilized to process the videos and/or the pictures to identify the sentiment of the attendee as they are speaking.

Identification of the sentiment of another attendee that is speaking may be performed at the attendee device of the attendee where the real-time transcript will be displayed. The identification of the sentiment of the speaking attendee may not be performed by the conferencing platform. In some example, the identification of the sentiment of the speaking attendee may occur at a different device than the attendee device. For example, the identification of the speaking attendee may be performed by a sentiment identification service executing at a separate device that is communicably coupled to the attendee device.

The identified sentiment of a speaking attendee may be embedded in the real-time text transcript as a sentiment indicator. For example, each word, sentence, paragraph, etc. of the real-time text transcript spoken by an attendee may be associated with a sentiment indicator embedded in the real-time text transcript. A sentiment indicator may include a symbol-based differentiator within the real-time text transcript symbolizing a particular sentiment corresponding to a portion of the real-time transcript associated with the symbol-based differentiator. The symbol-based differentiator may include a text tag, a colored tag, a shape, an emoticon, etc. that expresses a corresponding sentiment to the reader. For example, a symbol-based differentiator may include an angry face emoticon that appears next to a portion of the real-time text transcript that has been identified as being associated with an angry sentiment. Additionally, the sentiment indicator may include a font-based differentiator within the real-time text transcript symbolizing a particular sentiment corresponding to a portion of the real-time transcript with the font-based differentiator. A font-based indicator may include a style, a typeface, a color, a weight, a capitalization pattern, etc. that expresses a corresponding sentiment to the reader. For example, a font-based indicator may include displaying the portion of the real-time text transcript that has been identified as being associated with an angry sentiment as bold, red, all capitalized text.

At 454, the method 450 may include providing the real-time text transcript to the device during the meeting. As described above, the real-time text transcript may include the sentiment indicators.

Providing the real-time text transcript to the device during the meeting may include causing the real-time text transcript to be displayed on a display of the attendee's device during the meeting. The real-time text transcript may be displayed simultaneous with the user interface of the conferencing platform providing access to the meeting. As such, an impaired attendee utilizing the attendee device to access the meeting may simultaneously view visuals being displayed via the conferencing platform and the real-time transcript without altering the operation of the conferencing platform or disrupting the meeting flow.

At 456, the method 450 may include generating synthesized speech from non-speech input provided to the attendee device during the meeting. The conferencing platform may not be utilized to generate the synthesized speech from the non-speech input.

The synthesized speech may be delivered from the attendee device of a first attendee to a second attendee of the meeting. The synthesized speech may be delivered to the second attendee of the meeting by delivering the synthesized speech as an audio input into the conferencing platform at the device of the first attendee.

The production and/or delivery of the real-time text transcript, as described above, may generate privacy concerns. Meeting attendees may want to know that they are being recorded and/or that a transcript of their remarks is being prepared for the meeting. As such, the method 450 may include delivering an announcement at a start of the meeting that the real-time text transcript will be generated from the broadcast of the meeting. The announcement may be delivered by delivering audio of the announcement into the conferencing platform at the device. For example, the announcement may be delivered by streaming synthesized speech, announcing that the real-time text transcript will be generated, into an audio channel utilized as an audio input for the conferencing platform.

Additionally, for attendees participating in the meeting the unexpected interjection of a synthesized voice may be startling, distracting, and/or confusing. An attendee that is not expecting the synthesized voice to be broadcasted in the meeting, they may not understand the source of the synthesized voice and may assume that the conferencing platform is malfunctioning. As such, the method 450 may include delivering an announcement at a start of the meeting that the first attendee will be communicating via the synthesized speech. The announcement may be communicated by delivering audio of the announcement into the conferencing platform at the device. For example, the announcement may be delivered by streaming synthesized speech, announcing that the first attendee will be communicating via synthesized speech, into an audio channel utilized as an audio input for the conferencing platform.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure. Further, as used herein, “a plurality of” an element and/or feature can refer to more than one of such elements and/or features.

The figures herein follow a numbering convention in which the first digit corresponds to the drawing figure number and the remaining digits identify an element or component in the drawing. For example, a figure element 110 appearing in FIG. 1 may be the a same and/or similar element to a figure element 210 appearing in FIG. 2. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

What is claimed:

1. A system, comprising:
a processor; and
a non-transitory machine-readable storage medium to store instructions executable by the processor to:
generate synthesized speech from a non-speech input of a first attendee to a device logged into a meeting through a conferencing platform at the device; and
deliver the synthesized speech to a second attendee to the meeting as audio input into the conferencing platform.

2. The system of claim 1, including instructions executable by the processor to analyze audio of a meeting, captured from the conferencing platform providing access to the meeting, to identify a real-time communication gap during the meeting.

3. The system of claim 2, including instructions executable by the processor to delay the delivery of the synthesized speech until the real-time communication gap.

4. The system of claim 3, including instructions executable by the processor to override the delay of the delivery responsive to an indication by the first attendee to immediately share the synthesized speech.

5. The system of claim 3, including instructions executable by the processor to provide the first attendee an option to cancel the delivery of the synthesized speech after the non-speech input and prior to the real-time communication gap.

6. A non-transitory machine-readable storage medium comprising instructions executable by a processor to:
generate a real-time text transcript from audio of a meeting captured from a conferencing platform providing access to the meeting;
provide, in real-time during the meeting, the real-time text transcript to a device of a first attendee of the meeting logged in through the conferencing platform; and
deliver synthesized speech, synthetized from a non-speech input of the first attendee to the device, to a second attendee of the meeting by delivering the synthesized speech as audio input into the conferencing platform executing at the device.

7. The non-transitory machine-readable storage medium of claim 6, including instructions executable by the processor to provide, via the device, the first attendee with a selectable list of pre-formatted text inputs utilizable as the non-speech input.

8. The non-transitory machine-readable storage medium of claim 7, including instructions executable by the processor to populate the selectable list of pre-formatted text inputs from previously frequently utilized non-speech inputs from the first attendee, wherein the previously utilized non-speech inputs are identified by analysis of the real-time text transcript.

9. The non-transitory machine-readable storage medium of claim 6, including instructions executable by the processor to:
identify, by an analysis of the audio of the meeting captured from the conferencing platform providing access to the meeting, an attendee generating a portion of the audio; and
provide, in the real-time text transcript, an indicator attributing a portion of the real-time text transcript generated from the portion of the audio to the identified attendee generating the portion of the audio.

10. The non-transitory machine-readable storage medium of claim 6, including instructions executable by the processor to:
identify, by image processing of a user interface of the conferencing platform providing access to the meeting at the device, an attendee generating a portion of the audio; and
provide, in the real-time text transcript, an indicator attributing a portion of the real-time text transcript generated from the portion of the audio to the identified attendee generating the portion of the audio.

11. A method, comprising:
generating a real-time text transcript with a sentiment indicator from a broadcast of a meeting provided to a device of a first attendee via a conferencing platform providing access to the meeting;
providing the real-time text transcript with the sentiment indicator to the device during the meeting; and
delivering synthesized speech, synthetized from a non-speech input provided to the device during the meeting, to a second attendee of the meeting by delivering the synthesized speech as audio input into the conferencing platform at the device.

12. The method of claim 11, including delivering an announcement at a start of the meeting that the first attendee will be communicating via the synthesized speech by delivering audio of the announcement into the conferencing platform at the device.

13. The method of claim 11, including delivering an announcement at a start of the meeting that the real-time text transcript will be generated from the broadcast of the meeting by delivering audio of the announcement into the conferencing platform at the device.

14. The method of claim 11, wherein generating the real-time text transcript includes translating a first language spoken in the broadcast of the meeting to a second language to be included in the real-time text transcript.

15. The method of claim 11, including synthesizing the synthesized speech from the non-speech input, wherein synthesizing the synthesized speech includes translating the non-speech input from a first language to a second language to be utilized for the synthesized speech.
